(19) United States
(12) Patent Application Publication
(10) Pub. No.: US 2026/0300722 A1
(43) Pub. Date: Oct. 1, 2026

(54) MODEL ACQUISITION METHOD AND APPARATUS

(71) Applicant: Lenovo (Beijing) Limited, Beijing (CN)

(72) Inventors: Chenglei SHEN, Beijing (CN); Ming HE, Beijing (CN); Yan HAN, Beijing (CN)

(21) Appl. No.: 19/574,049

(22) Filed: Mar. 20, 2026

(30) Foreign Application Priority Data
Mar. 27, 2025 (CN) 202510376751.1

(51) Int. Cl. G06N 3/08; G06N 3/0475

(52) U.S. Cl. CPC G06N 3/08; G06N 3/0475

(57) ABSTRACT

A model acquisition method includes obtaining condition information needed for an initial model to execute a target task and representing an expected result requirement of the initial model executing the target task, performing denoising processing on an initial parameter, representing parameter noise of the initial model with respect to the target task, based on a diffusion model using the condition information as a constraint to obtain a target parameter, and updating the initial model using the target parameter to obtain a target model.

### CROSS-REFERENCE TO RELATED APPLICATION

This application claims priority to Chinese Patent Application No. 202510376751.1, filed on Mar. 27, 2025, the entire content of which is incorporated herein by reference.

### TECHNICAL FIELD

The present disclosure generally relates to the field of information technology and, more particularly, to a model acquisition method and apparatus.

### BACKGROUND

In practical applications, different tasks need varying degrees of parameter tuning for the model. However, currently, tuning the model parameters is labor-intensive, and the resulting model performance is often unsatisfactory.

### SUMMARY

In accordance with the present disclosure, there is provided a model acquisition method including obtaining condition information needed for an initial model to execute a target task and representing an expected result requirement of the initial model executing the target task, performing denoising processing on an initial parameter, representing parameter noise of the initial model with respect to the target task, based on a diffusion model using the condition information as a constraint to obtain a target parameter, and updating the initial model using the target parameter to obtain a target model.

Also in accordance with the present disclosure, there is provided an electronic device including a processor, and a memory storing an application program that, when executed by the processor, causes the electronic device to obtain condition information needed for an initial model to execute a target task and representing an expected result requirement of the initial model executing the target task, perform denoising processing on an initial parameter, representing parameter noise of the initial model with respect to the target task, based on a diffusion model using the condition information as a constraint to obtain a target parameter, and update the initial model using the target parameter to obtain a target model.

Also in accordance with the present disclosure, there is provided a non-transitory computer-readable storage medium storing an application program that, when executed by the processor, causes an electronic device including the processor to obtain condition information needed for an initial model to execute a target task and representing an expected result requirement of the initial model executing the target task, perform denoising processing on an initial parameter, representing parameter noise of the initial model with respect to the target task, based on a diffusion model using the condition information as a constraint to obtain a target parameter, and update the initial model using the target parameter to obtain a target model.

### BRIEF DESCRIPTION OF THE DRAWINGS

The above and other objects, features, and advantages of the present disclosure will become clearer from the following description of embodiments of the present disclosure with reference to the accompanying drawings.

FIG. 1 is a flowchart of a model acquisition method consistent with the present disclosure.

FIG. 2 is a flowchart of a diffusion model training method consistent with the present disclosure.

FIG. 3 is a flowchart of a method for obtaining first sample data consistent with the present disclosure.

FIG. 4 schematically shows the principle of a model acquisition method consistent with the present disclosure.

FIG. 5 is a schematic diagram of a model acquisition method consistent with the present disclosure.

FIG. 6 schematically shows a result of a model acquisition method consistent with the present disclosure.

FIG. 7 schematically shows another result of a model acquisition method consistent with the present disclosure.

FIG. 8 is a schematic structural diagram of a model acquisition apparatus consistent with the present disclosure.

FIG. 9 is a schematic structural diagram of an electronic device suitable for implementing the model acquisition method consistent with the present disclosure.

### DETAILED DESCRIPTION OF THE EMBODIMENTS

Embodiments of the present disclosure will be described with reference to the accompanying drawings. However, it should be understood that these descriptions are exemplary only and are not intended to limit the scope of the present disclosure. In the following detailed description, numerous specific details are set forth to provide a thorough understanding of the embodiments of the present disclosure for ease of explanation. However, it is obvious that one or more embodiments may be implemented without these specific details. Furthermore, descriptions of well-known structures and techniques are omitted in the following description to avoid unnecessarily obscuring the concepts of the present disclosure.

The terminology used herein is for the purpose of describing particular embodiments only and is not intended to limit the scope of the present disclosure. The terms “comprising,” “including,” etc., as used herein indicate the presence of features, processes, operations, and/or components, but do not exclude the presence or addition of one or more other features, processes, operations, or components.

All terms used herein (including technical and scientific terms) have the meaning commonly understood by those skilled in the art, unless otherwise defined. It should be noted that the terms used herein should be interpreted in a manner consistent with the context of this specification and should not be interpreted in an idealized or overly rigid manner.

When expressions such as “at least one of A, B, and C” or “at least one of A, B, or C” are used, they should generally be interpreted in accordance with the meaning commonly understood by those skilled in the art (e.g., “a system having at least one of A, B, and C” or “a system having at least one of A, B, or C” should include, but is not limited to, systems having A alone, having B alone, having C alone, having A and B, having A and C, having B and C, and/or having A, B, and C, etc.).

The present disclosure provides a model acquisition method and an apparatus.

In practical applications, different tasks need adjustments to model parameters to varying degrees. However, currently, adjusting model parameters is labor-intensive, and the adjusted models often exhibit poor performance.

For example, in a commercial recommendation system, the platform's or user's task requirements frequently change dynamically (e.g., changes in preference for the accuracy or diversity of recommendation results). To respond promptly to dynamic task requirements, multiple objectives (such as accuracy, diversity, etc.) can be combined to obtain an overall optimization objective, and then the model can be retrained to adapt to this new optimization objective. However, retraining the model is costly, time-consuming, and difficult to respond promptly to new task requirements. As another example, model fusion can be used to combine the outputs of multiple independent models to adapt to this new optimization objective. However, simple model parameter fusion makes it difficult to have fine-grained control over the performance of the fused model, and the performance of the fused model is often unstable.

The terms and concepts involved in the embodiments of the present disclosure are subject to the following interpretations.

Diffusion models are generative models that do not need an additional classifier. Instead, condition information is introduced directly into the model by jointly training conditional and unconditional diffusion models.

Classifier-Free Diffusion Models, introduce additional condition information (such as class labels, text descriptions, performance parameters, etc.) during the generation process through conditional diffusion model, thereby generating data (or parameters) that meet specific conditions.

The present disclosure provides a model acquisition method, including: obtaining first condition information needed for an initial model to execute a target task, the first condition information representing the expected result requirements of the initial model in executing the target task; using the first condition information as a constraint, denoising first initial parameters based on the diffusion model to obtain target parameters, the first initial parameters representing the parameter noise of the initial model with respect to the target task; updating the initial model using the target parameters to obtain a target model, so as to perform the target task using the target model.

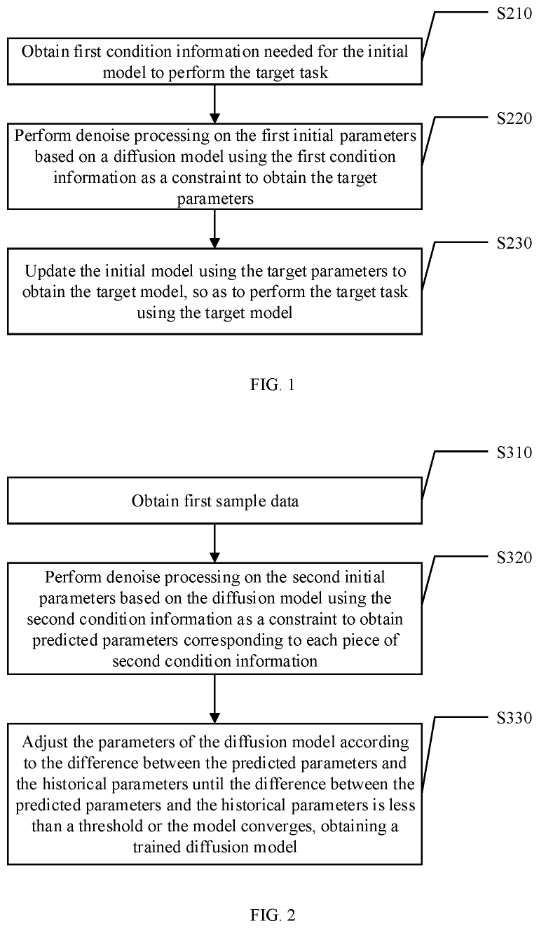

The model acquisition method of the present disclosure will be described in detail below with reference to FIGS. 1 to 7.

FIG. 1 is a flowchart of the model acquisition method consistent with the present disclosure.

As shown in FIG. 1, the model acquisition method of the present disclosure includes operations S210 to S230.

At S210, first condition information needed for the initial model to perform the target task is obtained. The first condition information represents the expected result requirement of the initial model executing the target task.

For example, the initial model can be a model of the target task to be performed. The result of the initial model's current model parameters executing the target task may not satisfy the first condition information.

The target task refers to the specific task or goal that the model needs to complete in a particular application scenario. For example, in a text-to-image scenario, the target task can be generating an image that meets the requirements based on the text. In the field of natural language processing, the target task can be generating a text that meets expectations based on input prompts, such as automatic writing. In e-commerce or social platforms, the target task can be recommending relevant products or content based on the user's historical behavior.

The first condition information is usually in text form and is used to constrain the denoising process of the diffusion model. In the present disclosure, the first condition information can be used to describe the expected result of the model when executing the target task. The first condition information can include one or more performance requirements. The first condition information can be an increase in types of performance requirement or a change in the weight of the performance requirement. The first condition information may vary depending on the target task. The first condition information may also vary depending on the weighting of performance requirements. For example, in a recommendation task, the first condition information can be that the accuracy and diversity of the recommendation results satisfy a first preset ratio, such as an accuracy: diversity ratio of 8:2. In another recommendation task, the first condition information can be the weights of the accuracy and diversity of the recommendation results satisfying a second preset ratio, for example, an accuracy: diversity ratio of 5:5. In the task of generating an image from text, the first condition information can be the accuracy, diversity, and image quality of the generated image.

At S220, using the first condition information as a constraint, the first initial parameters are denoised based on a diffusion model to obtain the target parameters. The first initial parameters represent the parameter noise of the initial model with respect to the target task.

For example, the first initial parameters can be the noise distribution of the original parameters (e.g., weights, biases, etc.) of the initial model executing the target task. The first initial parameters can be obtained through the following operations: obtaining the original parameters of the initial model, and adding noise to the original parameters over multiple time steps to obtain the first initial parameters.

If the initial model uses the original parameters to execute the target task, the execution result may not completely satisfy the first condition information. The original parameters can be randomly initialized, or can satisfy a Gaussian distribution or a normal distribution. Adding noise to the original parameters progressively over multiple time steps yields the first initial parameters, and the first initial parameters are a pure noise distribution.

The original parameters can be a subset of the parameters needed for the initial model to perform the target task. That is, based on the existing model, only a small number of parameters are adjusted to adapt to the new task, rather than retraining all parameters of the model. Updating partial parameters is to achieve task adaptation by updating partial parameters while preserving the model's general capabilities. The original parameters can also be full parameters needed for the initial model to perform the target task.

The diffusion model is used to denoise the first initial parameters using the first condition information as a constraint. During the denoising process, the first initial parameters are optimized and adjusted to generate target parameters that meet the requirements of the initial model for executing the target task. The initial model, when applying the target parameters to perform the target task, can meet the result requirements corresponding to the first condition information.

Different performance requirement weights correspond to different condition information of the target task, and different condition information corresponds to different target parameters. For the same target task, the target parameters change when the performance requirement weights change.

At S230, the initial model is updated using the target parameters to obtain the target model, so as to perform the target task using the target model.

For example, the target model is obtained by applying the target parameters to the initial model. The parameters of the initial model are adjusted using target parameters to form a target model adapted to the first condition information for executing the target task, thus responding to the first condition information of the target task.

By denoising the parameters of the initial model through a diffusion model, the target parameters needed to meet the result requirements of executing the target task can be obtained; and new task requirements of the model can be responded to instantly.

Simultaneously, the first condition information guides the diffusion model to optimize the parameters of the initial model, making the optimized initial model's parameters more accurate and stable, and the optimized initial model better meets the task requirements, improving the reliability of model application.

As mentioned above, at S220, using the first condition information as a constraint, the first initial parameters are denoised based on the diffusion model to obtain the target parameters. In one possible implementation, this operation can further include S221.

At S221, using the first condition information as a constraint, the initial parameters are gradually denoised over multiple time steps to obtain the target parameters; the target parameters represent the model parameters needed by the initial model when the execution result meets the first condition information.

For example, during the denoising process, the diffusion model inputs the first condition information as condition to guide the diffusion model in recovering target parameters from the noise that meet specific requirements (i.e., the execution result satisfies the first condition information). That is, the execution result of the initial model applying the target parameters to perform the target task satisfies the first condition information.

In some embodiments, for a recommendation model, in a new recommendation task, the first condition information is that the weights of accuracy and diversity of the recommendation results satisfy a first preset ratio of 8:2. In the process of obtaining the model parameters of the recommendation model for the new recommendation task, noise is added to the original parameters of the recommendation model over T time steps to obtain the first initial parameters. The first initial parameters are then input into the diffusion model. Given the first condition information, the diffusion model starts from these first initial parameters and, after T time steps of denoising, generates target parameters that satisfy the first condition information.

As mentioned above, during the denoising process, noise is predicted based on the current state at the current time step. The predicted noise is then used to update the current state to obtain the state for the next time step. The state is an intermediate representation of the diffusion model at a given time step, including both parameter information and noise information.

The state can be an intermediate representation at a certain time step during the diffusion process, meaning that some parameters are optimized while other parameters are noise. At time step t, the state

$${θ}_{n , t}^{a}$$

at time step t is neither pure data nor pure noise, but a mixture of both. As time step t decreases, the noise in the state

$${θ}_{n , t}^{a}$$

gradually decreases, while the data component gradually increases.

In some embodiments, for each time step t=T, T−1, . . . , 0, the diffusion model predicts noise

$$( \text{?} ( {θ}_{n , t}^{a} , {w}_{n} , t )$$

based on the current state

$${θ}_{n , t}^{a}$$

at the current time step t, and then uses the predicted noise

$$\text{?} ( {θ}_{n , t}^{a} , {w}_{n} , t )$$

to calculate the state

$${θ}_{n , t - 1}^{a}$$

at the next time step t−1 using a denoising update formula. Iterative denoising from t=T to t=0 generates the target parameters

$${θ}_{n , t}^{a} .$$

For example, denoising is performed progressively according to sampling method of the denoising diffusion probabilistic models (DDPM). The denoising update formula is as below.

$${θ}_{n , t - 1}^{a} = \frac{1}{\sqrt{{α}_{t}}} ( {θ}_{n , t}^{a} - \frac{{β}_{t}}{\sqrt{1 - {\overline{α}}_{t}}} \text{?} ( {θ}_{n , t}^{a} , {w}_{n} , t ) ) + {σ}_{t} {z}_{t}$$

where, βₜ is a set of hyperparameters, restricted to starting from β₁=10−4t and increasing linearly with time t to βₜ=0.02, αₜ=1−βₜ, σₜ is noise variance, and zₜ is random noise.

As mentioned above, the predicted noise includes conditional noise and unconditional noise. Conditional noise is generated under the constraint of the first condition information, while unconditional noise represents noise generated without constraints.

In some embodiments, for each time step, the diffusion model predicts the noise for that step. Under the Classifier-Free paradigm, the conditional noise and unconditional noise are recombine to generate the final noise prediction:

$$\text{?} ( {θ}_{n , t}^{a} , {w}_{n} , t ) = ( 1 + γ ) \text{?} ( {θ}_{n , t}^{a} , {w}_{n} , t ) - {γϵ}_{ξ} ( {θ}_{n , t}^{a} , t )$$

where γ is a hyperparameter.

$$\text{?} ( {θ}_{n , t}^{a} , {w}_{n} , t )$$

represents the predicted noise

$${ϵ}_{ξ} ( {θ}_{n , t}^{a} , {w}_{n} , t )$$

of the diffusion model output obtained with the condition information wₙ of task n as input and

$${ϵ}_{ξ} ( {θ}_{n , t}^{a} , t )$$

the diffusion model output obtained with wₙ=Ø as input.

Using the Classifier-Free approach to predict the conditional noise and unconditional noise of the diffusion model not only simplifies the process of generating conditional noise but also maintains the predictive ability of unconditional noise.

As mentioned above, the model acquisition method can further include obtaining the user's first attribute information and the second attribute information of multiple objects, inputting the first attribute information and the second attribute information of multiple objects into the target model to obtain multiple target objects, the multiple target objects satisfy the first requirement condition information.

The first attribute information can be information associated with the user. The first attribute information can include: the user's basic information and behavioral information. Basic information can include a user's age, gender, region, interests, preferences, etc. Behavioral information can include a user's web browsing data, product purchase data, etc.

Second attribute information can be association information of the object to be recommended. Second attribute information can include product's price, brand, function, etc.

In some embodiments, the initial model is a movie recommendation model. The requirement for the new recommendation task is that the weights of accuracy and diversity of the recommendation results meet a preset ratio of 8:2. The target parameters are obtained after processing with a diffusion model. The target parameters are loaded into the initial model to obtain the target model responding to the new recommendation task. When applying the target model, the user's first attribute information and the movie's second attribute information (e.g., year, genre, lead actor, etc.) are input into the target model. The target model outputs multiple recommended movies (target objects) for the user, and the accuracy and diversity of the multiple recommended movies meet a preset ratio of 8:2.

FIG. 2 is a flowchart of the diffusion model training method consistent with the present disclosure.

As described above, as shown in FIG. 2, the diffusion model is obtained through the following operations S310 to S330.

At S310, first sample data is obtained. The first sample data includes second condition information and historical parameters. The second condition information represents the requirement of result achieved by the initial model in executing historical tasks. The historical parameters represent the model parameters needed by the initial model when the execution result satisfies the second condition information.

At S320, using the second condition information as a constraint, the second initial parameters are denoised based on the diffusion model to obtain predicted parameters corresponding to each piece of second condition information. The second initial parameters represent the parameter noise of the diffusion model regarding the historical tasks.

At S330, the parameters of the diffusion model are adjusted according to the difference between the predicted parameters and the historical parameters until the difference between the predicted parameters and the historical parameters is less than a threshold or the model converges, and a trained diffusion model is obtained.

For example, the first sample data is an original dataset needed for training the diffusion model. The first sample data includes second condition information and historical parameters. The second condition information can be the requirement of result achieved by the initial model in executing historical tasks. The historical parameters can be the model parameters where the execution result of the initial model in executing historical tasks satisfies the second condition information.

For example, when the initial model is a recommendation model, the first sample data can include historical parameters corresponding to the condition information of multiple historical tasks, such as the parameters of the recommendation model when the weights of accuracy and diversity of the recommendation results satisfy 5:5, 1:9, and 3:7.

The second initial parameters can be the noise distribution of the original parameters (e.g., weights, biases, etc.) of the initial model when performing historical tasks. The second initial parameters can be obtained by following processes: obtaining the original parameters of the initial model, adding noise to the original parameters over multiple time steps, and obtaining the second initial parameters.

In some embodiments, the first sample data is input into the diffusion model to be trained. The diffusion model uses the second condition information of the historical tasks as conditions to denoise the second initial parameters. During the denoising process, the second initial parameters are optimized and adjusted to predict the predicted parameters needed by the initial model to perform historical tasks. By comparing the predicted parameters and historical parameters, the difference between the predicted parameters and the historical parameters is calculated, and the parameters of the diffusion model are continuously adjusted until the difference between the predicted result and the historical parameters of the diffusion model (ideal result) is less than a threshold (e.g., 0.5 or 1), and a trained diffusion model is obtained. The trained diffusion model can generate target parameters for an initial model based on the condition information of a new target task. The execution result of the initial model applying the target parameters to the new target task satisfies the first condition information.

In some embodiments, by comparing the predicted parameters and historical parameters and continuously adjusting the parameters of the diffusion model until the predicted parameters output by the diffusion model no longer change significantly and the model converges, a trained diffusion model is obtained.

As described above, at S320, using the second condition information as a constraint, the second initial parameters are denoised based on the diffusion model to obtain the predicted parameters corresponding to each piece of the second condition information. In one possible implementation, this operation can further include operation S321.

At S321, using the second condition information as a constraint, the second initial parameters are progressively denoised over multiple time steps to obtain the predicted parameters.

In the denoising process, noise is predicted based on the current state at the current time step. The predicted noise is then used to update the current state to obtain the state for the next time step. The state is an intermediate representation of the diffusion model at a given time step, including both parameter information and noise information.

The predicted noise includes conditional noise and unconditional noise. Conditional noise is generated under the constraint of the second condition information, while unconditional noise represents noise generated without constraints. During noise prediction, unconditional noise is generated and predicted based on the target probability.

Reference can be made to S221 above for denoising of the diffusion model during training process.

In some embodiments, the objective function of the diffusion model during training can be defined as follows:

$${l}_{diff} = {E}_{{θ}_{i , 𝕆}^{a} , ϵ ∼ ℕ ( 𝕆 , \text{?} ) , t} [ {\vert ϵ - {ϵ}_{ξ} ( {θ}_{n , t}^{a} , {w}_{n} , t ) \vert}^{2} ]$$

where i represents the historical tasks, t represents the time step of the diffusion process, E represents the diffusion model, whose input is the state

$${θ}_{i , t}^{a}$$

of task i at step t in the diffusion process, the condition information wᵢ of task i (e.g., weights

$${w}_{i}^{1}$$

for accuracy under condition 1 and weights

$${w}_{i}^{1}$$

for diversity under condition 2), and E represents Gaussian noise.

In Classifier-Free conditional training, to enable the diffusion model to recognize specific conditions while retaining general generative capabilities, the conditions are randomly set to null.

$${ϵ}_{ξ} ( {θ}_{i , t}^{a} , t ) = {ϵ}_{ξ} ( {θ}_{i , t}^{a} , {w}_{i} ) = ∅ , t )$$

where the weights wᵢ of the task i are randomly set to null according to the target probability.

Conditional noise is noise predicted by the diffusion model based on condition information (such as condition one). Unconditional noise is noise directly predicted by the diffusion model without relying on any condition information. At each process of denoising, the diffusion model recombines the conditional noise and unconditional noise predictions to generate the final predicted noise. During training, condition information is randomly discarded, and the condition information is set to null with a certain probability (e.g., 10%, 20%, etc.), allowing the diffusion model to generate unconditionally. This enables the diffusion model to learn to process both conditional and unconditional cases simultaneously.

It is understood that by randomly discarding condition information, the model is prevented from over-relying on condition information, thereby improving the flexibility and robustness of model generation.

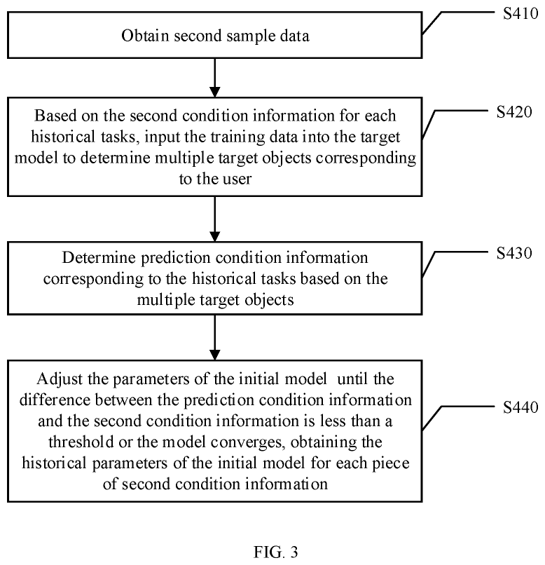

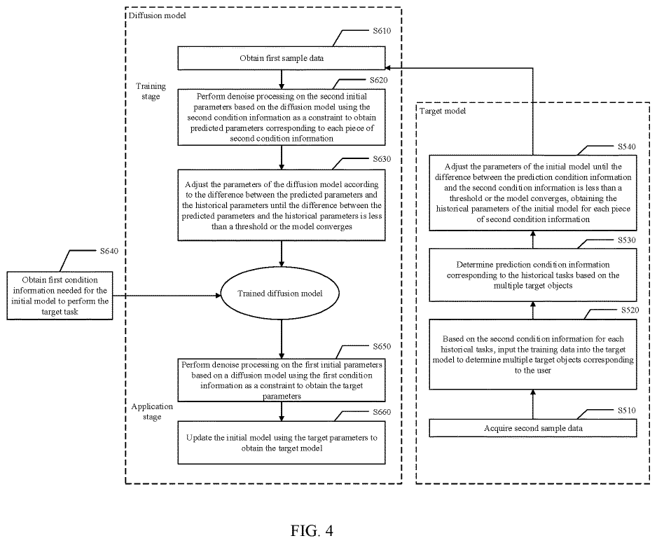

FIG. 3 is a flowchart of a method for obtaining first sample data consistent with the present disclosure.

As described above, at S310, first sample data is obtained. In one possible implementation, as shown in FIG. 3, this operation may further include S410 to S440.

At S410, second sample data is obtained. This second sample data includes training data and second condition information. The training data includes first attribute information for multiple users and second attribute information for multiple objects.

At S420, based on the second condition information for each historical task, the training data is input into the target model to determine multiple target objects corresponding to the user.

At S430, prediction condition information corresponding to the historical tasks is determined based on the multiple target objects.

At S440, the parameters of the initial model are adjusted until the difference between the prediction condition information and the second condition information is less than a threshold or the model converges, obtaining the historical parameters of the initial model for each piece of second condition information.

For example, the first attribute information can be information associated with the user. The first attribute information can include: the user's basic information and behavioral information. Basic information can be the user's age, gender, region, interests, preferences, etc. Behavioral information can be the user's web browsing data, product purchase data, etc.

The second attribute information can be the association information of the object to be recommended. The second attribute information can be product's price, brand, function, etc.

The second condition information represents the degree of emphasis that the expected execution results of multiple target objects exhibit under different conditions.

Prediction condition information represents the degree of emphasis shown by the execution results for multiple target objects under different conditions. For example, the weight ratio of accuracy to diversity of the recommendation results of multiple target objects for a user is 2:8.

In some embodiments, the target model is a recommendation model. The user's first attribute information and the movie's second attribute information (e.g., year, genre, lead actor, etc.) is input into the target model. The target model outputs multiple recommended movies (target objects) for the user, with a weighting ratio for accuracy and diversity of multiple movie recommendations is 3:7. This weight ratio of 3:7 differs from the second condition information (a weighting ratio for accuracy and diversity of multiple movie recommendations is 2:8). The parameters of the recommendation model are continuously adjusted until the difference between the predicted condition information and the second condition information (ideal result) is less than a threshold (e.g., 0.5 or 1), obtaining the model parameters (historical parameters) under the second condition information: the weighting ratio for accuracy and diversity of multiple movie recommendations is 2:8. These obtained model parameters and the second condition information can be used as the first sample data for training the diffusion model.

The gradient of the objective function with respect to each parameter in the initial model is calculated using relevant algorithms. The objective function is the result of merging the loss functions corresponding to multiple requirements in the second condition information.

Given specific task requirements w={w¹,w²}, representing the weights of different conditions under a specific task. The objective is optimized using LinearScalarization to obtain model parameters adapted to a specific task:

$${θ}^{a} = arg {min}_{{θ}^{a}} ( {w}^{1} {l}_{accuracy} + {w}^{2} {l}_{diversity} )$$

where w¹, w² represent the weights for condition one (e.g., accuracy) and condition two (e.g., diversity). l_{accuracy}, l_{diversity} represent the loss functions for the condition one and the condition two conditions, respectively. θ^{a} represents the target parameters of the model.

Based on the gradient, the parameters of the initial model are updated using gradient descent until the objective function reaches minimum value, obtaining the historical parameters of the initial model for each second condition.

As described above, at S230, the initial model is updated using the target parameters to obtain the target model. In one possible implementation, this operation may further include operation S231.

At S231, the target parameters are loaded into the adapter module of the initial model to obtain the target model.

For example, the adapter module may be a network layer inserted into the initial model to adapt to a new task. Upon receiving a new task, the backbone parameters of the initial model are fixed, and only the parameters of the adapter module are updated to obtain the target model adapted to the requirements of the new task.

The adapter parameters

$${θ}_{n , 0}^{a}$$

for the new task generated by the diffusion model are directly loaded into the adapter module connected to the backbone network of the recommendation model, thereby forming a new customized recommendation model to respond to the recommendation result requirements of the new task.

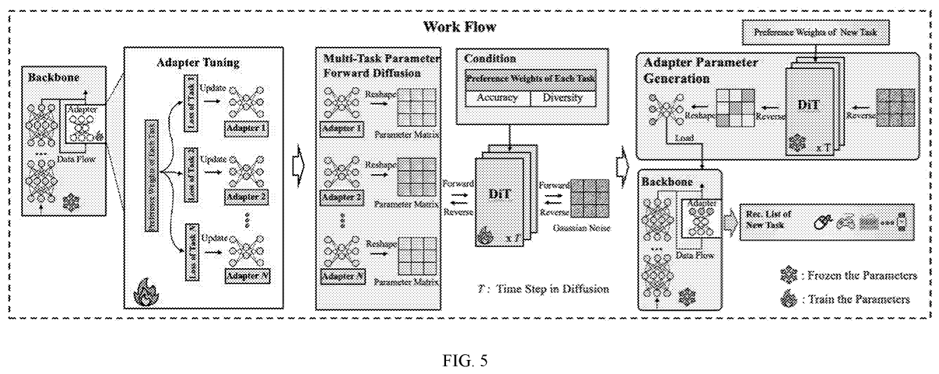

FIG. 4 schematically shows the principle of the model acquisition method consistent with the present disclosure. FIG. 5 is a schematic diagram of the model acquisition method consistent with the present disclosure.

The model acquisition method of the present disclosure includes three parts. First part is generating training data for the diffusion model using the model. Second part is training the diffusion model using the training data. Third part is generating model parameters corresponding to the condition information of the new task using the trained diffusion model.

1. First part is described as below.

The first sample data for training the diffusion model can be obtained by training the recommendation model. Obtaining the first sample data includes operations S510 to S540.

At S510, second sample data is obtained. The second sample data includes training data and second condition information. The training data includes first attribute information of multiple users and second attribute information of multiple objects.

At S520, based on the second condition information of each historical tasks, the training data is input into the target model to determine multiple target objects corresponding to the users.

At S530, prediction condition information corresponding to historical tasks is determined based on multiple target objects.

At S540, the parameters of the initial model are adjusted until the difference between the prediction condition information and the second condition information is less than a threshold or the model converges, obtaining the historical parameters of the initial model for each piece of the second condition information.

In some embodiments, referring to FIG. 5, the target model is a recommendation model, and an adapter structure adapted to different tasks is added to the recommendation model. The basic parameters of the recommendation model are fixed, and the adapter parameters of the adapter modules corresponding to the tasks in the backbone network need to be adjusted according to different task requirements (i.e., condition information). Correspondingly, adapter tuning (i.e., obtaining the first sample data): the adapter parameters are trained according to the requirements of different tasks to obtain the adapter parameters corresponding to the result requirements of different tasks, i.e., task 1 corresponds to adapter 1, task 2 corresponds to adapter 2, . . . , task N corresponds to adapter N, and each adapter contains adapter parameters corresponding to the task. Taking a historical task as an example, the user's first attribute information and the movie's second attribute information (e.g., year, genre, lead actor, etc.) are input into the target model. The target model outputs multiple recommended movies (target objects) for the user, with a weight ratio of 3:7 for accuracy and diversity among the recommended movies. This weight ratio of 3:7 differs from the second condition information (a weight ratio of 2:8 for accuracy and diversity among the recommended movies). The parameters of the recommendation model are updated based on this difference until the difference between the predicted condition information and the second condition information (ideal result) is less than a threshold (e.g., 0.5 or 1), obtaining the model parameters (historical parameters) under the second condition information: a weight ratio of 2:8 for accuracy and diversity of recommended movies. The obtained model parameters and the second condition information can be used as the first sample data for training the diffusion model.

2. Second part is described as below.

The training process of the diffusion model includes operations S610 to S630.

At S610, first sample data is obtained. The first sample data includes second condition information and historical parameters. The second condition information represents the requirement of result achieved by the initial model in executing historical tasks, and the historical parameters represent the model parameters needed by the initial model when the execution result satisfies the second condition information.

At S620, using the second condition information as a constraint, the second initial parameters are denoised based on the diffusion model to obtain predicted parameters corresponding to each piece of second condition information. These second initial parameters represent the parameter noise of the diffusion model regarding historical tasks.

At S630, based on the difference between the predicted parameters and historical parameters, the parameters of the diffusion model are adjusted until the difference between the predicted parameters and historical parameters is less than a threshold or the model converges, and a trained diffusion model is obtained.

In some embodiments, referring to FIG. 5, the first sample data obtained from adapter tuning is input into the diffusion model to be trained for multi-task parameter diffusion to update the diffusion model's parameters. The diffusion model generates data through a forward process (adding noise) and a reverse process (denoising). Forward Process: Obtain the original parameters generated by the recommendation model based on the second condition information of the historical tasks, add noise to the original parameters over T time steps to obtain the second initial parameters (Gaussian noise). Reverse Process: The diffusion model uses the second condition information of the historical tasks as a condition and denoises the second initial parameters over T time steps. During denoising, the second initial parameters are optimized and adjusted to predict the predicted parameters needed for the initial model to execute the historical tasks. By comparing the predicted parameters and historical parameters, the difference between the predicted parameters and the historical parameters is calculated, and the parameters of the diffusion model are continuously adjusted until the difference between the predicted result and the historical parameters of the diffusion model (ideal result) is less than a threshold (e.g., 0.5 or 1), and a trained diffusion model is obtained. The trained diffusion model can generate target parameters for the initial model based on the condition information of the new target task (e.g., the weights of accuracy and diversity of the execution result in the target task condition information). The execution result of the initial model applying the target parameters to execute the new target task satisfies the first condition information.

3. Third part is described as below.

The model acquisition method of the present disclosure may include operations S640 to S660.

At S640, the first condition information needed for the initial model to perform the target task is obtained. The first condition information represents the expected result of the initial model executing the target task.

At S650, using the first condition information as a constraint, the first initial parameters are denoised based on the diffusion model to obtain the target parameters. The first initial parameters represent the parameter noise of the initial model with respect to the target task.

At S660, the initial model is updated using the target parameters to obtain the target model, the target model is then used to perform the target task.

In some embodiments, refer to FIG. 5, for a recommendation model, in a new recommendation task, the first condition information is that the weights of accuracy and diversity of the recommendation results satisfy a first preset ratio of 8:2. The adapter parameters are generated using the diffusion model based on the conditional weights of the new task. In the process of obtaining the model parameters (adapter parameters) of the recommendation model for the new recommendation task, the forward process is adding noise to the original parameters of the recommendation model over T time steps to obtain the first initial parameters. The reverse process is inputting the first initial parameters into the diffusion model, given the first condition information, and the diffusion model, starting from the first initial parameters, denoising over T time steps to generate the target parameters that satisfy the first condition information. The target parameters are directly loaded into the adapter connected to the backbone network of the recommendation model, thereby forming a new customized recommendation model to respond to the recommendation result requirements of new tasks.

Based on different lists of new tasks (including the condition information of the new tasks), the trained diffusion model is used to generate different adapter parameters for different new tasks, thus obtaining recommendation models adapted to different new tasks.

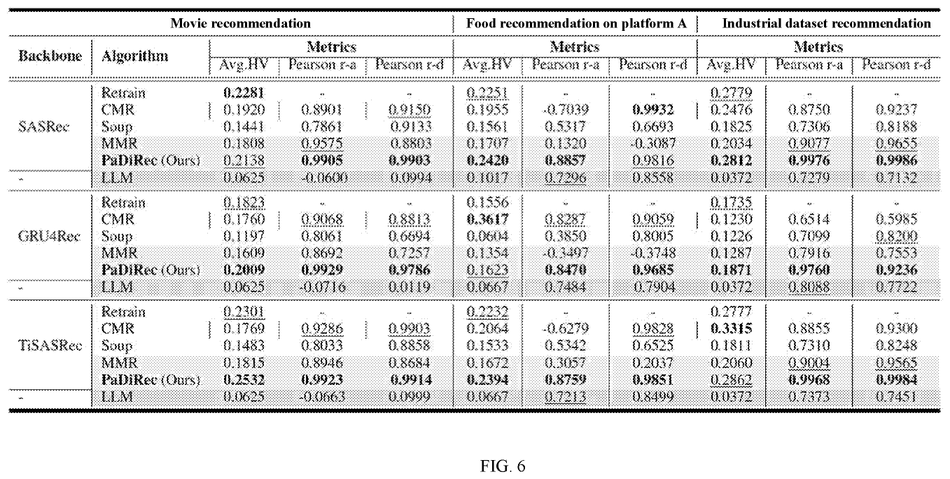

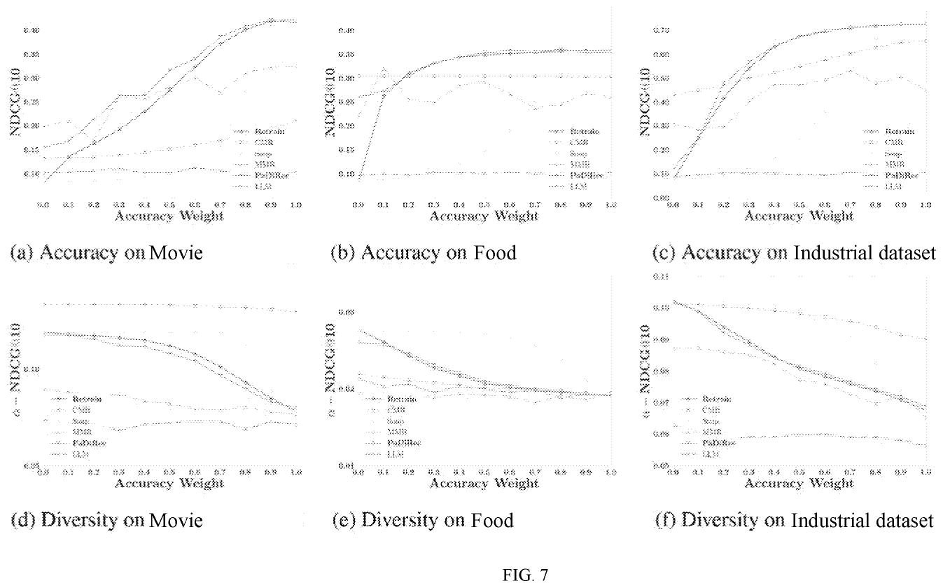

FIG. 6 schematically shows one result of the model acquisition method consistent with the present disclosure. FIG. 7 schematically shows another result of the model acquisition method consistent with the present disclosure.

To verify the performance of applying the target parameters of the condition information of the target task obtained by the model acquisition method of the present disclosure to the recommendation model and executing the target task, the backbone network of the recommendation model adopts a sequence recommendation model based on self-attention mechanism (SASRec), a sequence recommendation model based on Gated Recurrent Unit (GRU4Rec), and a sequence recommendation model based on time-based self-attention mechanism (TiSASRec), respectively.

The algorithm includes the following.
(1) Retrain retrains the obtained recommendation model according to the condition information of the target task.
(2) CMR (controllable multi-objective re-ranking with policy hypernetworks) is a controllable re-ranking method for multi-objective ranking, combining policy hypernetworks to optimize ranking tasks of multiple objectives. CMR can be used for effective re-ranking under multiple ranking criteria and can adjusted these objectives as needed.
(3) Soup (Model soups): averaging weights of multiple fine-tuned models improves accuracy without increasing inference time.
(4) MMR (diversity-based reranking for reordering documents and producing summaries) is a document ranking and summarization technique designed to select the most representative documents or sentences in a retrieval system.
(5) PaDiRec is a recommendation model that applies objective parameters obtained using the model acquisition method of the present disclosure to condition information of the objective task.
(6) LLM (Large Language Model) is a large language model capable of understanding and generating natural language text.

The evaluation targets are as follows: Task 1: Movie recommendation; Task 2: Food recommendation on Platform A; and Task 3: An industrial dataset related to recommendations.
Evaluation metric 1: The correlation between condition 1 and the algorithm (Avg. HV) is obtained by averaging the Hvpervolume of the multi-objective task under multiple task weights, measuring the overall performance of the algorithm on a single task.
Evaluation metric 2: The correlation between condition 2 and the algorithm (Pearsonr-aPearsonr-d) measures the correlation between the two objectives (accuracy and diversity) and the algorithm of the retrained recommendation model.

The recommendation model obtained in the embodiments of the present disclosure and recommendation models using different algorithms to execute on the same objective task respectively, and the results are shown in FIG. 6. Analysis of FIG. 6 shows that the recommendation model using the target parameters obtained by the model acquisition method of the present disclosure, based on the condition information of the target task, performs well overall in the recommendation task. In the movie recommendation task using a self-attention backbone network, the recommendation model using the method of the present disclosure maintains a small performance gap with the recommendation model retrained based on the condition information of the target task. For other tasks and algorithms, the overall performance of the recommendation model using the method of the present disclosure is better than that of the recommendation model retrained based on the condition information of the target task.

FIG. 7 shows the result of the recommendation model obtained by the present disclosure and recommendation models using different algorithms when performing multiple target tasks, respectively, regarding the result requirements. Analysis of FIG. 7 shows that, under the weights of multiple sets of condition information—accuracy and diversity—the change curves of the recommendation model using the target parameters obtained by the model acquisition method of the present disclosure and the recommendation model retrained based on the condition information of the target task have the closest trends.

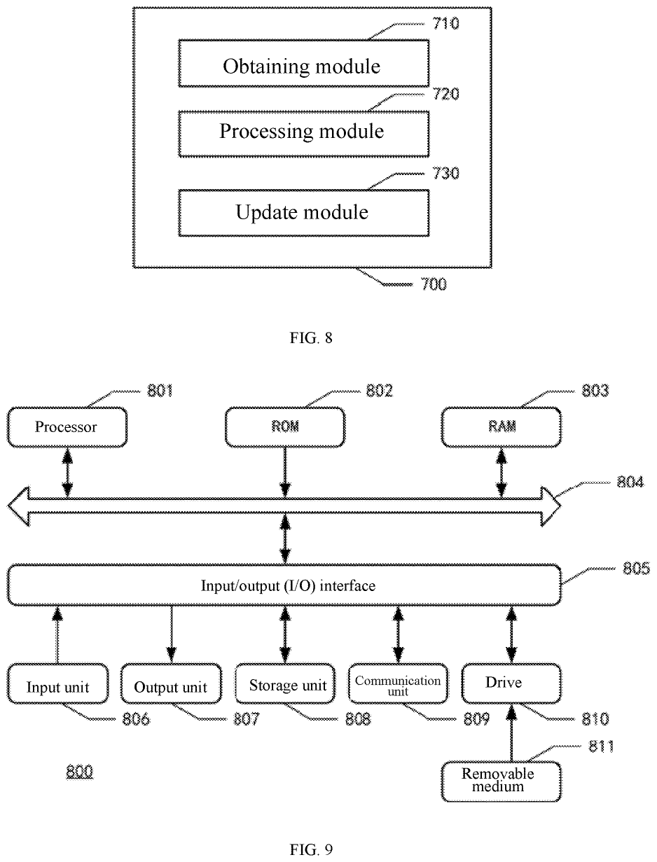

Based on the above model acquisition method, the present disclosure also provides a model acquisition apparatus. The apparatus will be described in detail below with reference to FIG. 8.

FIG. 8 shows a schematic structural diagram of the model acquisition apparatus consistent with the present disclosure.

As shown in FIG. 8, the model acquisition apparatus 700 of the present disclosure includes an acquisition module 710, a processing module 720, and an update module 730.

The obtaining module 710 is used to obtain first condition information needed for the initial model to perform the target task. The first condition information represents the expected result requirement of the initial model in executing the target task. In some embodiments, the acquisition module 710 can be used to perform the operation S210 described above.

The processing module 720 is used to perform denoising processing on the first initial parameters based on the diffusion model, using the first condition information as a constraint, to obtain target parameters. The first initial parameters represent the parameter noise of the initial model with respect to the target task. In some embodiments, the processing module 720 can be used to perform the operation S220 described above.

The update module 730 is used to update the initial model using the target parameters to obtain the target model, so as to perform the target task using the target model. In some embodiments, the update module 730 can be used to perform the operation S230 described above.

According to embodiments of the present disclosure, any plurality of modules among the acquisition module 710, processing module 720, and update module 730 can be combined into one module, or any one of these modules can be split into multiple modules. As another example, at least a portion of the functionality of one or more of these modules can be combined with at least a portion of the functionality of other modules and implemented in one module. According to embodiments of the present disclosure, at least one of the acquisition module 710, processing module 720, or update module 730 can be at least partially implemented as hardware circuit, such as a Field-Programmable Gate Array (FPGA), a Programmable Logic Array (PLA), a System-on-a-Chip, a System-on-a-Substrate, a System-on-Package, an Application-Specific Integrated Circuit (ASIC), or any other reasonable method of integrating or packaging circuit, such as hardware or firmware, or as any suitable combination of software, hardware, and firmware implementations. As another example, at least one of the acquisition module 710, processing module 720, or update module 730 can be at least partially implemented as a computer program module, when executed, can perform corresponding functions.

FIG. 9 a schematic structural diagram an electronic device suitable for implementing the model acquisition method consistent with the present disclosure.

As shown in FIG. 9, the electronic device 800 consistent with the present disclosure includes a processor 801, which can perform various appropriate actions and processes based on a program stored in a read-only memory (ROM) 802 or a program loaded from a storage unit 808 into a random access memory (RAM) 803. Processor 801 may include, for example, a general-purpose microprocessor (e.g., a CPU), an instruction set processor and/or an associated chipset and/or a special-purpose microprocessor (e.g., an application-specific integrated circuit (ASIC)), etc. Processor 801 may also include onboard memory for caching purposes. Processor 801 may include a single processing unit or multiple processing units for performing different actions of the method according to embodiments of the present disclosure.

In RAM 803, various programs and data needed for the operation of electronic device 800 are stored. Processor 801, ROM 802, and RAM 803 are interconnected via bus 804. Processor 801 performs various operations of the method according to embodiments of the present disclosure by executing programs in ROM 802 and/or RAM 803. It should be noted that programs may also be stored in one or more memories other than ROM 802 and RAM 803. Processor 801 may also perform various operations of the method according to embodiments of the present disclosure by executing programs stored in one or more memories.

According to embodiments of the present disclosure, the electronic device 800 may further include an input/output (I/O) interface 805 connected to a bus 804. The electronic device 800 may also include one or more of the following components connected to the I/O interface 805: an input unit 806 including a keyboard, mouse, etc.; an output unit 807 including a cathode ray tube (CRT), liquid crystal display (LCD), and a speaker, etc.; a storage unit 808 including a hard disk, etc.; and a communication unit 809 including a network interface card such as a LAN card, modem, etc. The communication unit 809 performs communication processing via a network such as the Internet. A drive 810 is also connected to the I/O interface 805 as needed. A removable medium 811, such as a disk, optical disk, magneto-optical disk, semiconductor memory, etc., is installed on the drive 810 as needed so that computer programs read from the removable medium 811 can be installed into the storage unit 808 as needed.

The present disclosure also provides a computer-readable storage medium, the computer-readable storage medium can be included in the device/apparatus/system described in the above embodiments, or may exist independently and not assembled into the device/apparatus/system. The computer-readable storage medium carries one or more programs that, when executed, implement the method consistent with the present disclosure.

According to embodiments of the present disclosure, the computer-readable storage medium may be a non-volatile computer-readable storage medium, such as including but not limited to: portable computer disks, hard disks, random access memory (RAM), read-only memory (ROM), erasable programmable read-only memory (EPROM or flash memory), portable compact disk read-only memory (CD-ROM), optical storage devices, magnetic storage devices, or any suitable combination thereof. In the present disclosure, the computer-readable storage medium may be any tangible medium that includes or stores a program that can be used by or in conjunction with an instruction execution system, apparatus, or device. For example, according to embodiments of the present disclosure, the computer-readable storage medium may include ROM 802 and/or RAM 803 and/or one or more memories other than ROM 802 and RAM 803 described above.

Embodiments of the present disclosure also include a computer program product including a computer program containing program code for performing the methods shown in the flowchart. When the computer program product is run on a computer system, the program code enables the computer system to implement the model acquisition method provided in the embodiments of the present disclosure.

When the computer program is executed by processor 801, the computer program performs the functions defined in the system/apparatus of the embodiments of the present disclosure. According to embodiments of the present disclosure, the systems, apparatuses, modules, units, etc., described above can be implemented by computer program modules.

In some embodiments, the computer program can rely on tangible storage media such as optical storage devices or magnetic storage devices. In another embodiment, the computer program can also be transmitted and distributed in the form of signals over a network medium and downloaded and installed via communication unit 809, and/or installed from removable medium 811. The program code contained in the computer program can be transmitted using any suitable network medium, including but not limited to: wireless, wired, etc., or any suitable combination thereof.

In the present disclosure, the computer program can be downloaded and installed from a network via communication unit 809, and/or installed from removable medium 811. When the computer program is executed by processor 801, the computer program performs the functions defined in the system of the present disclosure embodiment. According to embodiments of the present disclosure, the systems, devices, apparatuses, modules, units, etc., described above can be implemented by computer program modules.

According to embodiments of the present disclosure, program code for executing the computer programs provided in the embodiments of the present disclosure can be written in any combination of one or more programming languages. Specifically, these computational programs can be implemented using high-level procedural and/or object-oriented programming languages, and/or assembly/machine languages. Programming languages include, but are not limited to, languages such as Java, C++, Python, “C,” or similar programming languages. The program code can be executed entirely on the user's computing device, partially on the user's device, partially on a remote computing device, or entirely on a remote computing device or server. In cases involving remote computing devices, the remote computing device can be connected to the user's computing device via any type of network, including a local area network (LAN) or a wide area network (WAN), or an external computing device (e.g., via the Internet using an Internet service provider).

The flowcharts and block diagrams in the accompanying drawings illustrate the architecture, functionality, and operation of possible implementations of systems, methods, and computer program products according to various embodiments of the present disclosure. Each block in a flowchart or block diagram may represent a module, segment, or portion of code containing one or more executable instructions for implementing a specified logical function. It should also be noted that in some embodiments, the functions indicated in the blocks may occur in a different order than those indicated in the drawings. For example, two consecutively indicated blocks may actually be executed substantially in parallel, and sometimes in reverse order, depending on the functions involved. It should also be noted that each block in a block diagram or flowchart, and combinations of blocks in a block diagram or flowchart, may be implemented using a dedicated hardware-based system that performs the specified function or operation, or using a combination of dedicated hardware and computer instructions.

Those skilled in the art will understand that the features recited in the various embodiments and/or claims of the present disclosure can be combined or combined in various ways, even if such combinations or combinations are not expressly described in the present disclosure. In particular, the features recited in the various embodiments and/or claims of the present disclosure can be combined and/or combined in various ways without departing from the spirit and teachings of the present disclosure. All such combinations and/or combinations fall within the scope of the present disclosure.

The embodiments of the present disclosure have been described above. However, these embodiments are for illustrative purposes only and are not intended to limit the scope of the present disclosure. Although various embodiments have been described above, this does not mean that the measures in the various embodiments cannot be used advantageously in combination. The scope of the present disclosure is defined by the appended claims and their equivalents. Various substitutions and modifications can be made by those skilled in the art without departing from the scope of the present disclosure, and all such substitutions and modifications should fall within the scope of the present disclosure.

What is claimed is:

1. A model acquisition method comprising:
obtaining condition information needed for an initial model to execute a target task, the condition information representing an expected result requirement of the initial model executing the target task;
performing denoising processing on an initial parameter based on a diffusion model using the condition information as a constraint to obtain a target parameter, the initial parameter representing parameter noise of the initial model with respect to the target task; and
updating the initial model using the target parameter to obtain a target model.

2. The method according to claim 1, wherein performing denoising processing on the initial parameters includes:
progressively removing noise from the initial parameter over a plurality of time steps using the condition information as the constraint to obtain the target parameter, the target parameter representing a model parameter needed by the initial model when an execution result satisfies the condition information.

3. The method according to claim 2, wherein during the denoising process, the noise is predicted based on a current state of a current time step of the plurality of time steps to obtain predicted noise, and the predicted noise is used to update the current state to obtain a state of a next time step of the plurality of time steps, the state of one time step of the plurality of time steps being an intermediate representation of the diffusion model at the one time step and including parameter information and noise information.

4. The method according to claim 3, wherein the predicted noise includes conditional noise and unconditional noise, the conditional noise being generated using the condition information as the constraint, and the unconditional noise being generated without constraints.

5. The method according to claim 1, further comprising:
obtaining first attribute information of a user and second attribute information of a plurality of objects; and
inputting the first attribute information and the second attribute information into the target model to obtain a plurality of target objects that satisfy the condition information.

6. The method according to claim 1, wherein:
the condition information is first condition information; and
the diffusion model is obtained by:
obtaining sample data including second condition information and a historical parameter, the second condition information representing a result requirement achieved by the initial model in executing a historical task, and the historical parameter representing a model parameter needed by the initial model when an execution result satisfies the second condition information;
performing denoising processing on a second initial parameter based on the diffusion model using the second condition information as a constraint to obtain a predicted parameter corresponding to the second condition information, the second initial parameter representing parameter noise of the diffusion model with respect to the historical task; and
adjusting a parameter of the diffusion model according to a difference between the predicted parameter and the historical parameter until the difference is less than a threshold or the model converges, to obtain the diffusion model that has completed training.

7. The method according to claim 6, wherein performing denoising processing on the second initial parameter includes:
progressively removing noise from the second initial parameter over a plurality of time steps using the second condition information as the constraint to obtain the predicted parameter.

8. The method according to claim 7, wherein during the denoising process, noise is predicted based on a current state of a current time step of the plurality of time steps to obtain predicted noise, and the predicted noise is used to update the current state to obtain a state of a next time step of the plurality of time steps, the state of one time step of the plurality of time steps being an intermediate representation of the diffusion model at the one time step and including parameter information and noise information.

9. The method according to claim 8, wherein the predicted noise includes conditional noise and unconditional noise, the conditional noise being generated using the first condition information as the constraint, the unconditional noise being generated without constraints, and the unconditional noise being predicted and generated with a target probability during noise prediction process.

10. The method according to claim 6, wherein:
the sample data is first sample data; and
obtaining the first sample data includes:
obtaining second sample data including training data and the second condition information, the training data including first attribute information of a plurality of users and second attribute information of a plurality of objects;
inputting the training data into the target model based on the second condition information of the historical task, and determining a plurality of target objects corresponding to the plurality of users;
determining prediction condition information corresponding to the historical task based on the plurality of target objects; and
adjusting a parameter of the initial model until a difference between the prediction condition information and the second condition information is less than a threshold or the model converges, to obtain a historical parameter of the initial model for each piece of second condition information.

11. The method according to claim 1, wherein updating the initial model using the target parameter to obtain the target model includes:
loading the target parameter into an adapter module of the initial model to obtain the target model.

12. An electronic device comprising:
a processor, and
a memory storing an application program that, when executed by the processor, causes the electronic device to:
obtain condition information needed for an initial model to execute a target task, the condition information representing an expected result requirement of the initial model executing the target task;
perform denoising processing on an initial parameter based on a diffusion model using the condition information as a constraint to obtain a target parameter, the initial parameter representing parameter noise of the initial model with respect to the target task; and
update the initial model using the target parameter to obtain a target model.

13. The electronic device according to claim 12, wherein the application program, when executed by the processor, further causes the electronic device to, when performing denoising processing on the initial parameters:
progressively remove noise from the initial parameter over a plurality of time steps using the condition information as the constraint to obtain the target parameter, the target parameter representing a model parameter needed by the initial model when an execution result satisfies the condition information.

14. The electronic device according to claim 13, wherein during the denoising process, the noise is predicted based on a current state of a current time step of the plurality of time steps to obtain predicted noise, and the predicted noise is used to update the current state to obtain a state of a next time step of the plurality of time steps, the state of one time step of the plurality of time steps being an intermediate representation of the diffusion model at the one time step and including parameter information and noise information.

15. The electronic device according to claim 14, wherein the predicted noise includes conditional noise and unconditional noise, the conditional noise being generated using the condition information as the constraint, and the unconditional noise being generated without constraints.

16. The electronic device according to claim 12, wherein the application program, when executed by the processor, further causes the electronic device to:
obtain first attribute information of a user and second attribute information of a plurality of objects; and
input the first attribute information and the second attribute information into the target model to obtain a plurality of target objects that satisfy the condition information.

17. The electronic device according to claim 12, wherein:
the condition information is first condition information; and
the diffusion model is obtained by:
obtaining sample data including second condition information and a historical parameter, the second condition information representing a result requirement achieved by the initial model in executing a historical task, and the historical parameter representing a model parameter needed by the initial model when an execution result satisfies the second condition information;
performing denoising processing on a second initial parameter based on the diffusion model using the second condition information as a constraint to obtain a predicted parameter corresponding to the second condition information, the second initial parameter representing parameter noise of the diffusion model with respect to the historical task; and
adjusting a parameter of the diffusion model according to a difference between the predicted parameter and the historical parameter until the difference is less than a threshold or the model converges, to obtain the diffusion model that has completed training.

18. The electronic device according to claim 17, wherein the application program, when executed by the processor, further causes the electronic device to, when performing denoising processing on the second initial parameter:
progressively remove noise from the second initial parameter over a plurality of time steps using the second condition information as the constraint to obtain the predicted parameter.

19. The electronic device according to claim 18, wherein during the denoising process, noise is predicted based on a current state of a current time step of the plurality of time steps to obtain predicted noise, and the predicted noise is used to update the current state to obtain a state of a next time step of the plurality of time steps, the state of one time step of the plurality of time steps being an intermediate representation of the diffusion model at the one time step and including parameter information and noise information.

20. A non-transitory computer-readable storage medium storing an application program that, when executed by the processor, causes an electronic device including the processor to:
obtain condition information needed for an initial model to execute a target task, the condition information representing an expected result requirement of the initial model executing the target task;
perform denoising processing on an initial parameter based on a diffusion model using the condition information as a constraint to obtain a target parameter, the initial parameter representing parameter noise of the initial model with respect to the target task; and
update the initial model using the target parameter to obtain a target model.
